(19) United States
(12) Patent Application Publication
(10) Pub. No.: US 2007/0165401 A1
(43) Pub. Date: Jul. 19, 2007

(54) Assembled flash display module

(76) Inventor: Ching Sung Lin, Taoyaun City (TW)

Correspondence Address: TROXELL LAW OFFICE PLLC, SUITE 1404, 5205 LEESBURG PIKE, FALLS CHURCH, VA, 22041, US

(21) Appl. No.: 11/332,181

(22) Filed: Jan. 17, 2006

(51) Int. Cl. F21V 9/00

(52) U.S. Cl. 362/231

(57) ABSTRACT

An assembled flash display module comprising a shell body, a flash lamp set and a control unit is disclosed. The shell body is disposed with an accommodation space therein. The flash lamp set is arranged in said accommodation space and consists of at least two flash lamps that emit different colors of light. The flash lamps and the control unit are electrically connected. The control unit further comprises a trigger circuit and a regulating circuit, through which, the on time of trigger electrode of flash lamps is controlled to regulate the flashing intensity of the flash lamps. The present invention offers multiple color flashes and more luminous display in comparison with other light-emitting display units, and hence is more useful in practical applications.

### BACKGROUND OF INVENTION

1. Field of the Invention

The present invention relates to an assembled flash display module, more particularly a kind of flash display module that combines two or more flash lamps emitting different colors of light and employs a control unit to control the flashing intensity of the lamps to alter the light color of the entire assembly.

2. Description of the Prior Art

The advancement of technology has brought many new technologies into our lives and adds to the convenience of life. In the example of display technology, currently large outdoor display panel makes use of highly luminous LED. But the overall luminance of a LED display has much room for improvement, especially during the day when there is plenty of sunlight. Due to the presence of intense light around it, LED display becomes inadequately illuminated in broad daylight, and its overall display effect is unsatisfactory. Many business places, such as pubs and dance halls, also use highly luminous flashing lights in business signage or interior lighting. Those flashing lights emit continuous luminous rays to achieve dazzling visual effect or attract attentions. Many car or motorcycle owners would also install flashing light at the tail of vehicle that emit flashes intermittently as alarm or to remind approaching vehicles behind.

Flash lamps available on the market work by increasing voltage with a transformer and using a capacitor for storage and charging, and then passing the high voltage generated by trigger circuit through the trigger electrode of flash lamp to ionize the gas in the lamp and finally generate highly intense light energy. But up to now, flash lamps on the market only emit monochromatic light, which can be monotonous and hardly satisfies the demands for color variation. If a business owner desires to have multi-colored flashing lights, he needs to install multiple flash lamps that emit different colors of light at the same time, which takes space but and adds to the costs of installation.

To address the aforesaid drawback, this inventor embarked on research combined with theoretical applications, and after continuous trials and improvements, finally come up with an ingenious design of assembled flash display module that affectively addresses the drawback of prior art.

### SUMMARY OF INVENTION

The primary object-of the present invention is to provide an assembled flash display module which may be adjusted and emit high-intensity lights of different colors based on actual needs.

Another object of the present invention is to provide an assembled flash display module which can have flashing colors adjusted and produce high-intensity light, and is hence applicable to large display or outdoor advertising board.

To achieve the aforesaid objects, the present invention-comprises a shell body, a flash lamp set and a control unit, wherein the shell body is disposed with an accommodation space therein. The flash lamp set is arranged in said accommodation space and consists of at least two flash lamps that emit different colors of light. The flash lamps and the control unit are electrically connected. The control unit further comprises a trigger circuit and a regulating circuit, through which, the on time of trigger electrode of flash lamps is controlled to regulate the flashing intensity of the flash lamps so as to produce multiple color variations.

The assembled flash display module of the invention is described in detail below with accompanying drawings.

### BRIEF DESCRIPTION OF THE DRAWINGS

The details of the present invention will be more readily understood from a detailed description of the preferred embodiments taken in conjunction with the following figures.

FIG. 1 is a block diagram of the invention.

FIG. 2 is an exploded view of a preferred embodiment of the invention.

FIG. 3 is the circuitry of a preferred embodiment of the invention.

### DETAILED DESCRIPTION

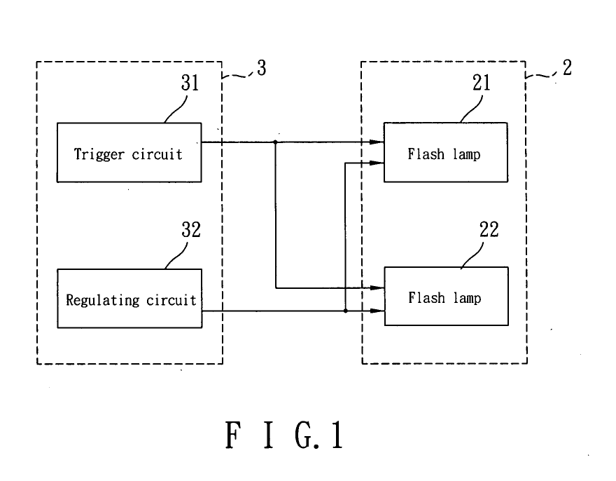

Referring to FIG. 1 which shows a block diagram of the invention, the assembled flash display module comprises a shell body 1, a flash lamp set 2 and a control unit 3, wherein the shell body 1 is disposed with an accommodation space therein. The flash lamp set 2 is arranged in the accommodation space of shell body 1 and consists of at least two flash lamps 21, 22 that emit different colors of light. The flash lamps 21, 22 and the control unit 3 are electrically connected. The control unit 3 further comprises a trigger circuit 31 and a regulating circuit 32, through which, the on time of trigger electrode of flash lamps 21, 22 is controlled to regulate the flashing intensity of the flash lamps 21, 22, and the mixing of those two colors produce multiple color variations in between.

The structure described above allows the regulation of the flashing intensity of flash lamps 21, 22 to achieve color change according to actual needs. In comparison with prior monochromatic flash lamps that are both monotonous and impractical, the present invention can adjust light intensity and emit flashes of different colors, and save considerable space.

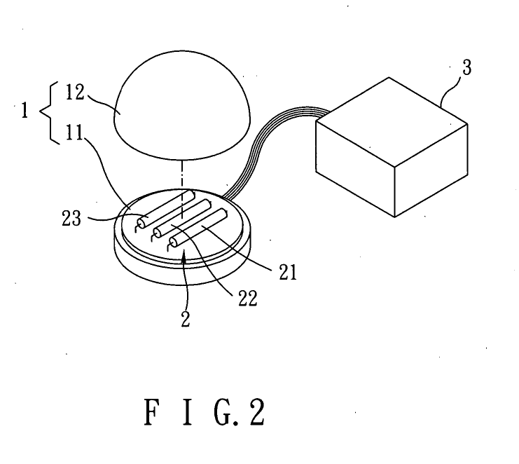

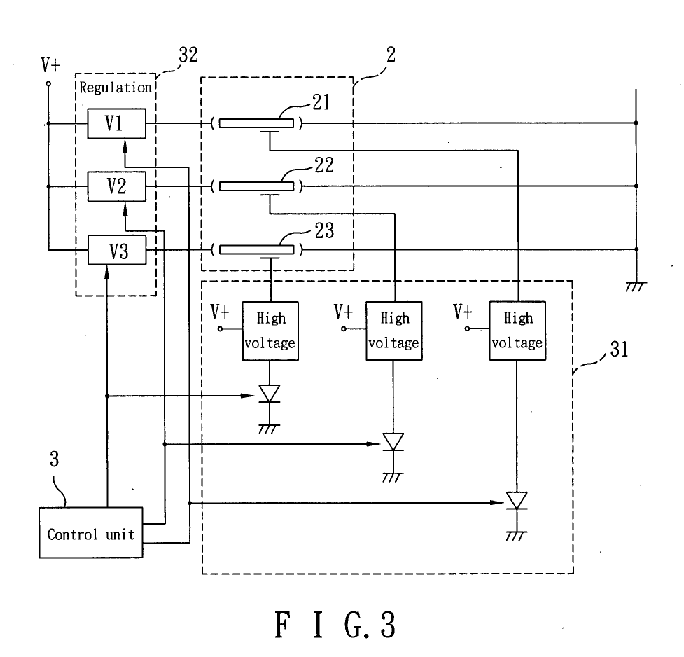

Referring to FIG. 2 and FIG. 3 which are respectively an exploded view and circuitry of a preferred embodiment of the invention, the flash lamp set 2 consists of three flash lamps 21, 22, 23 that emit right, blue, and green lights respectively. By controlling the red, blue and green flash lamps 21, 22, 23 with a control unit 3, the three flash lamps emit lights of different intensity individually or simultaneously based on actual needs to obtain a mixture of light of different colors and achieve the objective of color variations.

In the aforesaid structure, the shell body 1 further consists of a base 11 and a cover 12. The cover 12 is a backlight panel with harmonizing effect to spread and harmonize the light energies emitted from flash lamps 21, 22, 23 of different colors.

It is clear from the description above that the design of the present invention can control and change the color of light and its flashing frequency according to actual needs. On the other hand, its flashing intensity is stronger than other light sources (e.g. conventional light bulb, energy saving light bulb or light-emitting diode) on the market. With its high brightness feature, the present invention can be applied to all kinds of large display, advertising board, stage lighting, and indoor or outdoor alarm devices to produce excellent effect.

The assembled flash display module of the present invention features simple structure and change of flashing colors at will. In comparison with prior flashing device that fire flash of single color, the present invention can be widely applied and allows more variations. When used in outdoor large display panel or advertising board, the present invention offers excellent luminosity and display effect.

What is claimed is:

1. An assembled flash display module, comprising:
a shell body with an accommodation space therein;
a flash lamp set arranged in the accommodation space of shell body and consists of at least two flash lamps that emit different colors of light; and
a control unit electrically connected to the flash lamps that emit different colors of light and able to regulate the flashing intensity and trigger time of the flash lamps so flashes of different color variations can be produced after the flashes from the flash lamps are mixed.

2. The assembled flash display module according to claim 1, wherein said flash lamp set further consists of flash lamps that emit respectively red, green and blue light.

3. The assembled flash display module according to claim 1, wherein said shell body further consists of a base and a cover.

4. The assembled flash display module according to claim 3, wherein the cover is a backlight panel with harmonizing effect.

5. The assembled flash display module according to claim 1, wherein said control unit further consists of a trigger circuit and a regulating circuit.
